(19) United States
(12) Patent Application Publication
(10) Pub. No.: US 2023/0217245 A1
(43) Pub. Date: Jul. 6, 2023

(54) SYSTEM AND METHOD ASSOCIATED WITH SETTING PARAMETERS TO INITIATE DIALOGUE USING WIRELESS NETWORK TECHNOLOGY

(71) Applicant: DAMIAN HENDERSON, Dallas, TX (US)

(72) Inventor: DAMIAN HENDERSON, Dallas, TX (US)

(21) Appl. No.: 17/566,663

(22) Filed: Dec. 30, 2021

(51) Int. Cl. H04W 12/033; H04W 12/63

(52) U.S. Cl. CPC H04W 12/033; H04W 12/63

(57) ABSTRACT

The present invention can securely detect devices in proximity to desired location via wireless access points and GPS. The invention can configure devices and wireless networks based on components technological makeup and adhere the components to admin protocols. The invention can identify what devices are being used to connect to a wireless or area and determine what medium of communication is to be used based on the component’s ability or availability.

### BACKGROUND

### Field of Invention

The present invention contains the embodiment of innovation that encourages stimulation and growth. The present invention incorporates accountability, efficiency, security, and scalability using SYSTEM and METHOD ASSOCIATED WITH SETTING PARAMETERS to INITIATE DIALOUGE using WIRELESS NETWORK TECHNOLOGY.

Embodiments of the present invention generally relates to the field of wireless networking. Various embodiments relate to access points and mobile computing devices, with regards to security, wireless networks, devices, accountability, data transferring, and documentation involving administrators and users that use multiple wireless network technologies in multiple environments. Background

Any discussion of documents, acts, materials, devices, articles or the like which has been included in this specification is solely for providing a context for the present invention. It is not to be taken as an admission that any of these matters form part of the prior art base or were common general knowledge in the field relevant to the present invention as it existed in USA or elsewhere before the priority date of this application.

The present invention recognize that wireless network technology can be utilized for more of a specializes concentration. I came across the situation where I was waiting outside of a building to pick up my daughter from school. Schools have check-in or carpool lines that require check-in with the teachers or staff to pick a up child. Staff try to secure this process and make it efficient as much as possible with laminated window stickers or mirror hangers; but a lot of times is still very inefficient.

Other issues included the large amount of paperwork that the school was sending home with the child. The paperwork included school handouts, report cards, progress reports, book fair advertisements, announcements and much more. This tied in directly to the amount of paper that the school required from parents as part of what students needed for school supplies.

I overheard a conversation from a employee with Children’s advocate agency disclose issues related to not being prepared to document certain interactions. A lot of times the employee would go to a house or location for a case and the situation would escalate. The employee would not have time to properly document the situation based on the aggressive nature of the situation.

Issues with how co-parents are affected when parents exchange ownership of a child at certain locations is considered. Possible hostile situations can be avoided when accountability is decided based on word of mouth.

Why not have the employee automatically connect to a wireless network which will initiate device automatically activate the microphone or the camera as to record based on the wireless network that you’re connecting to; also adding GPS coordinates to solidify the location.

The present invention uses the wireless network inside of schools as a medium to verify, connect to announce arrival, automatically correspond with guardians and staff, and announce departure; while documenting all actions to announce the arrival other person to pick up their child.

The arriving party will connect to the wireless network. The administrator on the other end of the network who was able to see the arriving party, which initiates the releasing process. Documenting who is releasing the child and who was picking the child up.

Also using the wireless network to facilitate the transfer of data between staff and guardians to reduce the carbon footprint from idling fuel burning cars and from paper distribution form the school. Securing the wireless network play a huge part in this process when accessing a child’s private records, medication information, or behavior records.

The present invention can be used in multiple scenarios when involving the arrival and departure of people coming and going to and from a location. Accountability, security, efficiency, and analytics play an important role in how interaction is perceived. The present invention answers the question related to maximizing growing wireless technical resources to promote innovation, stimulate growth, and increase efficiency; while offering security, accountability, and efficiency.

Multiple environments are rapidly moving in the direction of wireless network technologies. Wireless networks have made the process of streaming videos, online gaming, or internet browsing easier as Wireless enabled devices are more and more utilized.

Using wireless or fidelity technology to transmit data has emerged to be a widespread and key technology. Many devices including smartphones, laptops, tablets, computers, digital cameras, smartwatches, televisions to name a few uses or will use some form data transmitting wireless technology.

Access points offer data flow and connection with convenience of using versions wireless technology. All mentioned technologies offer connection but at the cost of limited range, exposure being compromised, and security limitations. Wireless networks can extend from an area as small as a square inch to as large as many square kilometers, achieved by using multiple overlapping access points. There are established access points that offer the convenience of freely or randomly connecting. There are other established locations that offer connection at a premium; but are not fully utilizing the flexibility of what a wireless network technology can offer to its users.

The relevance of mentioning wardriving is to show potential of malicious intent. Around the year 2000, an engineer named Peter Shipley coined the term wardriving to refer to the practice of deliberately searching a local area looking wireless network signals. Mr. Shipley pioneered the practice of using an automobile, a Global Positioning System (GPS), and a mounted antenna to identify unsecured wireless home networks.

The relevance of mentioning some deficiencies with wireless network uses is to show limitations. Giving access credentials to users require the reissuing of credentials every time the password or user name is changed. Other issues include unwanted sharing of the network passwords, as well as password users gaining unwanted access at unwanted times. Protocols put into place to govern how individuals utilize wireless networks are more than unsatisfactory and far from efficient.

Unsecured or open networks have detrimental repercussions. Criminals can create networks in buildings to attract unsuspecting people to view information on the person’s device. Unsecured or open networks can reduce bandwidth resulting in slower data transfer. Unsecured networks can allow users to view and perform illegal activities; inappropriate websites, perform malicious activities to the wireless network (changing configuration), fraudulent activities, and stolen identity by packet sniffing transferred plain text as well as virus spreading with little to no consequence or repercussions. At times, network owners are penalized for illegal activities.

The relevance of mentioning GPS is to show inaccuracies in how some locations identify users. A Global Positioning System (GPS) provides a way of tracking and navigating to locations. Using GPS can be convenient; allowing many users to utilize smart devices and offer a way for business to get user feedback if the user visited a location. Since GPS devices rely on satellites, they are not perfectly suited for multilevel structures. Interference from dense foliage, increment weather conditions, walls or physical barriers, and multi frequency interference can have negative affect.

The relevance of mentioning E-Mail is to show inefficiency and lack of reliability. Electronic mail, email, or e-mail is defined as the transmission of messages over communications networks. Typically, the messages are notes entered from an input device. Keyboard, or electronic files stored on disk. Most mainframes, minicomputers, and computer networks have an email system. While readily available and widely used, E-Mail pose undesirable issues. E-Mails are not efficient. E-mail do not send a receive confirmation until the email is opened by the addressee, not when it received by the addressee. Email inboxes can become full and be mistaken for spam. E-mail is one of the most common ways for viruses to travel and infect or compromise a device. E-mails can be sent anonymously, which means that they are sometimes used maliciously to bully or upset people. E-mail is susceptible to hacking.

The relevance of mentioning SMS (Short message service) or MMS (Multi Media Service) is to show inefficiency and lack of reliability. SMS and MMS offer convenience as well as ease of use. This has proven to be a greatly used way to transmit messages and media. Issues that are faced with SMS and MMS range from verifying the receipt of the message to establishing that the message was sent. In some cases, it is not possible to send or receive a SMS or MMS while being on a voice call.

The sender of the SMS or MMS can document the messages sent by time and date stamp, but there is no guarantee the recipient will receive the message. The message is time and date stamped by the recipient once the recipient’s device can receive the SMS or MMS. Powered off devices are bad coverage represent detrimental issues for both senders and recipients. Another draw back to SMS and MMS is that the wireless service provider cannot document when the attempt to send the message was attempted or when the SMS and MMS was received.

The relevance of mentioning paper handouts is to show inefficiency and lack of reliability. Communicating using paper has been around for thousands of years. Paper is easily and readily available at little cost. Paper is widespread and wide used throughout the world. Once data is transferred to paper, the level of confidentiality substantially decreases due to the opportunity of remanufacturing. Paper handouts can potentially be misplaced or mistakenly thrown away.

The amount of space that paper occupies dramatically decrease the efficiency in area use. More important the carbon footprint used in the manufacturing of paper is overwhelming. 14 million trees are cut down yearly for the manufacturing of paper. In the process of the production of paper bags, thousands of gallons of fresh water and bleach are used to clean the pulp.

The relevance of mentioning Check points is to show inefficiency and lack of reliability. Check points or sign in locations are common regarding documenting and verifying approaching people. It is not uncommon for individuals to leave identifications at the front desk when visiting a location. Generally, access or visitor badges are handed out and the identification is returned to the visitor once the badge is returned to the Front desk personnel. In many cases, time and dates are documented as the individual enters and exits the location. Issues that arise from this method is there are times when the individual forgets to return the badge to the front desk personnel.

This results in a wasted trip back to the location for the individual, costly badge replacement, or the individual’s identification being misplaced by front desk personnel due to personnel change in at the check in location. There have been documented issues where information on identification cards have been stolen by a unwanted onlooker, or identification cards are given to the wrong visitor upon departure. Allowing visitors to sign in and document their own time sometimes result in confusion or user error.

Many of the mediums used to transfer and communicate data can experience network outages that require the device user to reset network options on the device that is being used. Keep in mind that once a network reset is attempted, every password that is saved on the device that grants access to a wireless network is lost and must be re-entered. While wireless networks are accessible, they can be used to expedite processes related to the communication between network personnel and network non-personnel in a more secure and efficient method.

### SUMMERY

### Terminology

To lower confusion in the text, “Device(s)” will represent mobile computing device(s), vehicles with mac address technology(ies), touch screen device(s), badge(s), detector(s), decoder(s), reader(s), camera(s), printer(s), data or media output device(s), speaker(s), microphone(s), transceiver(s), smart monitor(s), analyzer(s), and smart accessory(s). To lower confusion in the text, “wireless network technology(ies)” will represent router(s), access point(s), SSID(s), vehicles with access point or hotspot technology(ies), Modem(s), Switch(s) radio(s), Mi-Fi, HSPA+, G.hn, HomePlug, Zigbee, Mesh network, Bluetooth, WiMAX, LTE, Wi-Fi, Li-Fi, Vi-Fi or using vibration to transmit data, So-Fi or using sound to transmit data, radiation, Bluetooth, 802 working groups. To lower confusion, “user(s)” will represent user(s) seeking, being offered, has been granted wireless network access. To lower confusion, “Administrator(s)” will represent users with wireless network administrative permissions. To lower confusion, “detail(s)” will represent information that is related to a wireless network technology(ies) as well as device(s) of user(s) and administrator(s) and personal, private, public, general detail(s) related to user(s) and administrator(s). To lower confusion in the text, “data or media” will represent sound, visual, vibration, molecular, and/or abstract content that can be submitted and/or received using the invention in question

The invention is a downloadable or installable application for devices. The invention facilitates the process of collecting, documenting, and verifying details of wireless network technology(ies), device(s) details related to users and administrators, and details related to users and administrators.

The invention will use details that are collected related to wireless network technology(ies), devices related to users and administrators, and personal details related to users and administrators to make a profile that is used to add devices and calculate configuration needs by determining what actions are taken for wireless network technology(ies) discoverability and connection between users and administrators using said devices and wireless network technology(ies); to establish and maintain a secured connection.

The invention allows administrators the flexibility send access invites and to stipulate which specific of the details are needed to allow discoverability, access, a maintained secured connection, and restrict access of said wireless network technology(ies) for specific users and administrators of said wireless network technology(ies).

The invention allows a wireless network technology(ies) administrator to conceal or show wireless network technology(ies) details to users.

The invention allows administrators to grant users administrative permissions of a wireless network technology(ies).

The invention allows administrators of wireless network technology(ies) to change passwords that may continue to allow wireless network technology(ies) access without divulging changes to users.

When a administrators’ or users’ device(s) connect, correspond data/media, or disconnect to access granted wireless network technology(ies), the invention sends notifications to users’ device and the device of the administrators’ governing the wireless network technology(ies) via said wireless network technology(ies) for the user or multiple wireless network or mediums for administrators.

The invention allows approved devices to discover, connect, and maintain connection to approved wireless network technology(ies). Once connection is made, the invention initiates the configuration of technology(ies) a device may have in order to receive transferred data/media.

The invention allows configuration of device(s) available technology to adapt and switch within a wireless network technology(ies) to send and receive data/media

The invention facilitates a form of band steering that allow device(s) the flexibility to maximize signal strength.

The invention facilitates a form of adapter strength modifications in devices that relate to wireless network technology(ies) connection.

The invention allows administrators of a wireless network technology(i)es the flexibility of sending data/media in real-time, open dialogue of data/media, or pre-determined data/media by time, date, user, and frequency.

The invention allows approved devices that discover and connect to approved wireless network technology(ies) to initiate the process of configuring device(s), adjusting signal strength level to send/receive data/media, or access wireless network technology(ies) based on a access point; having real-time and/or preset data/media defined as encrypted unharmful data/media intertwined with malicious software when said data is sent from the device and before said data/media reaches the server via a wireless network technology(ies). Said data being received by users’ and administrators’ devices, decrypted and malicious software is filtered out and/ or quarantined by the as part of the invention.

The invention allows administrators to monitor one or more wireless network technology(ies) while simultaneously becoming a user on a wireless network technology(ies).

The inventions allow administrators of a wireless network technology the ability to access wireless network technology(ies) remotely form alternative wireless resources or while connected to a physical access point on the administered wireless network or medium.

The invention uses a parameter calendar as a viewable calendar interface on a device(s) that is used to determine parameters for sending data/media to users and opening dialogue functionality.

The invention uses a documentation calendar to document all transactions, notifications, and correspondence between users and administrators while utilizing wireless network technology(ies) and make documentation visible and searchable in the flexible internal calendar or added calendar of devices of administrators and users that may be used for analytical purposes.

The invention differentiates how users and administrators disconnect from wireless network technology(ies).

### BRIEF DESCRIPTION OF THE DRAWINGS

The invention may best be understood by referring to the following description and accompanying drawings that are used to illustrate embodiments of the invention. In the drawings:

FIG. 1A is a flow diagram from the perspective of an administrator in accordance with an embodiment of the present invention.

FIG. 1B is a flow diagram from the perspective of a user in accordance with an embodiment of the present invention.

FIG. 2 illustrates a diagram of an administrator being a user. FIG. 2 illustrates preventing theft of transferred data.

FIG. 3 illustrates a diagram multiple user device being configured in connection process to specific access points.

FIG. 4A. The present example illustrates the status screen for networks and users; and the progression of how an administrator may use parameter interface functions in selecting designations for data related to networks and users.

FIG. 4B. The present example illustrates an elaboration of how an administrator may choose parameters for data being sent.

FIG. 5 The present example illustrates the calendar for documentation interface on a device(s).

FIG. 6 The present example illustrates multiple access points and parameters at a location.

FIG. 7 The present example illustrates multiple locations and criteria when connected to a wireless network at specific locations.

### DETAILED DESCRIPTION

### Terminology

To lower confusion in the text, “Device(s)” will represent mobile computing device(s), vehicles with mac address technology(ies), touch screen device(s), badge(s), detector(s), decoder(s), reader(s), camera(s), printer(s), data or media output device(s), speaker(s), microphone(s), transceiver(s), smart monitor(s), analyzer(s), and smart accessory(s). To lower confusion in the text, “wireless network technology(ies)” will represent router(s), access point(s), SSID(s), vehicles with access point or hotspot technology(ies), Modem(s), Switch(s) radio(s), Mi-Fi, HSPA+, G.hn, HomePlug, Zigbee, Mesh network, Bluetooth, WiMAX, Lte, Wi-Fi, Li-Fi, Vi-Fi or using vibration to transmit data, So-Fi or using sound to transmit data, radiation, Bluetooth, 802 working groups. To lower confusion, “user(s)” will represent user(s) seeking, being offered, has been granted wireless network access. To lower confusion, “Administrator(s)” will represent users with wireless network administrative permissions. To lower confusion, “detail(s)” will represent information that is related to a wireless network technology(ies) as well as device(s) of user(s) and administrator(s) and personal, private, public, general detail(s) related to user(s) and administrator(s). To lower confusion in the text, “data or media” will represent sound, visual, vibration, molecular, and/or abstract content that can be submitted and/or received using the invention in question

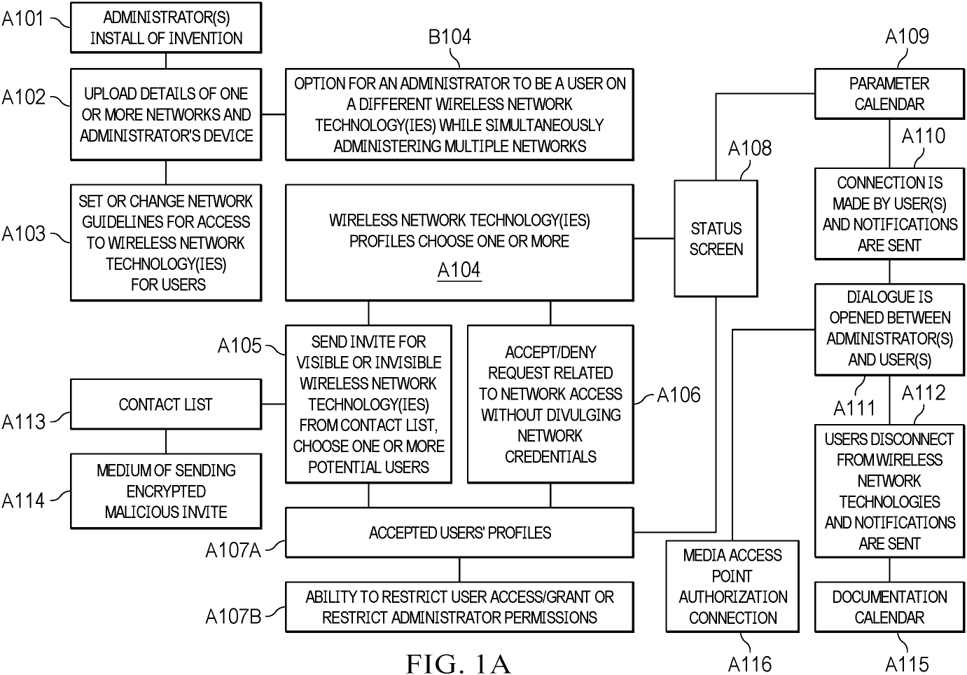

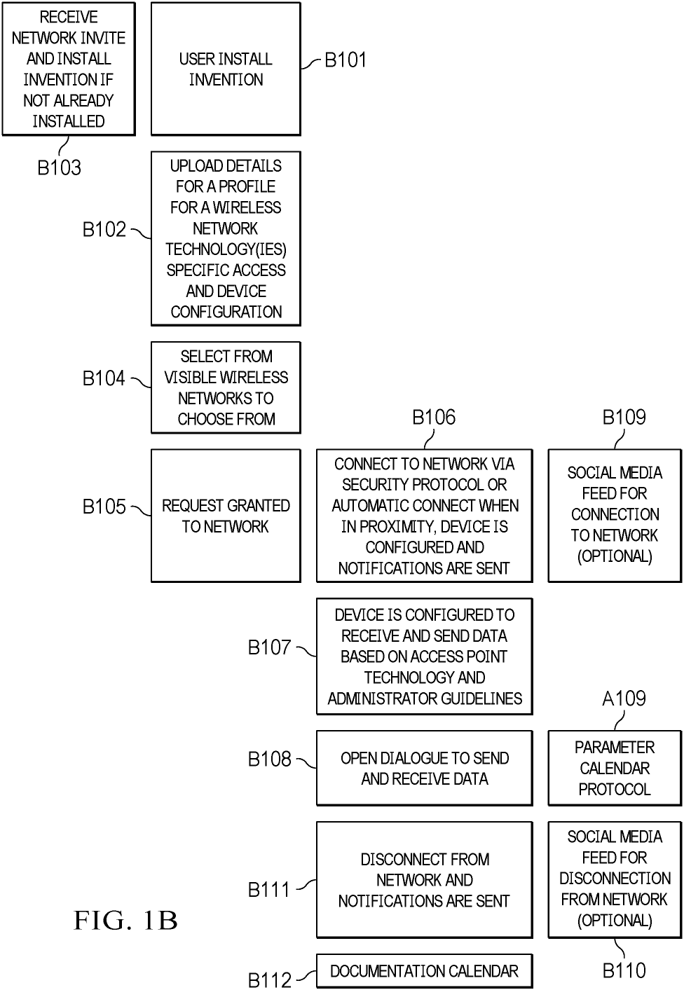

FIG. 1A is a flow diagram illustrating the administrator(s) installing the invention on a device, as an administrator(s). The present example illustrates the upload personal details, wireless network technology(ies) details, and device(s) for the purpose of a verification protocol the grants specific devise access. The present example illustrates the governing of wireless network technology(ies) using specific devices through the point in time of connection, data correspondence of users, disconnection from a wireless network technology by a user(s), notifications for actions and documentation of actions. The present example illustrates the flow or process as an administrator(s) governs wireless network technology(ies) using devices, through the point in time of disconnection from a wireless network technology by a user(s); at a time when the invention is presently synced with the administrator(s)′ device(s). The present example illustrates invention manually or automatically gathering administrator(s) details, administrator’s device details, and or administrator(s) wireless network technology(ies)to upload for wireless network technology(ies) related to stipulations that administrator(s) must have to set and change permissions and guidelines related to a wireless network technology(ies). The present example illustrates that a user will not have wireless network technologies passwords. Names of devices and wireless network components can be masked to reflect something other than what they are. The present example illustrates the procees of a administrator granting network access without divulging network credentials. The present example illustrates a profile of users’ details that are available for administrator(s) that may or may not be viewable by an administrator(s). The present example illustrates the point that administrator(s) may or may not have the ability to view details of the user even though the details are collected. The present example illustrates the administrator(s) setting wireless network technology(ies) access preferences. The present example illustrates the administrator(s) granting or denying wireless network technology(ies) access for a users’ device. The present example illustrates the administrator making wireless network technology visible or invisible to users’ device(s). The present example illustrates the administrator extending wireless network technology(ies) access to a user(s) and sending an embedded link to download the invention to the users’ device if the user does not have the invention presently synced to a device of the user(s). The present example illustrates the administrator(s) selecting what data is sent, when the data is sent, what frequency the data is sent, what destination within wireless network technology(ies) will initiate the process of connection and data being sent, and whom is to receive the data. The present example illustrates open dialogue and parameters. The present example illustrates multilanguage capabilities.

FIG. 1A. The present example illustrates the sending of notifications and the documentation for analytics: of actions related to wireless network technologies being viewable by the administrator(s). The present example illustrates A101 represents administrator(s) install of invention. A102 represents upload details of one or more networks and administrator’s device. B104 represents the option for an administrator to be a user on a different wireless network technology(ies) while simultaneously administering multiple networks. B104 relates to the process of a user network access protocol. A103 represents set or change network guidelines for access to wireless network technology(ies) for users (Network guidelines include but not limited to determining what of the user’s details are needed for access, what functionality on users’ devices will be activated, device restrictions while connected to a network, documented actions of users while connected to network). A104 represents wireless network technology(ies) profiles choose one or more. A105 represents send invite for visible or invisible wireless network technology(ies) from contact list chooses one or more potential users. A106 represents accept/deny request related to network access without divulging network credentials. A107A represents accepted users’ profiles (section for adding multiple devices and or users to a profile) (restrict, deny connection of users) (details of users and devices) place to change users’ permissions (all details may be may not be visible to the administrator(s)) Information that is collected for users can be used in a profile. A107B represents ability to restrict user access/ grant or restrict administrator permissions. A108 represents status screen. One or more users can be selected related to networks the users potentially have access to gateway to see user status and wireless network technologies status. A109 represents parameter calendar. A110 represents connection is made by user(s) and notifications are sent. A111 represents dialogue (video, audio documented, etc.), is opened between administrator(s) and user(s). A116 represents media access point authorization connection (printer, speaker, etc....) that will distribute dialogue in a tangible (visual, audio) format. Ex. The administrator may send a document to a user that requires a signature. The user may confirm or affirm that the document is approved. A116 represent that the media is sent to a source that can be seen, heard, or felt. A112 represents users disconnect (manually or leave proximity) from wireless network technologies and notifications are sent. A113 represents contact list. A114 represents medium of sending encrypted malicious invite. A115 represents documentation calendar. The present example illustrates the sending of notifications and the documentation for analytics; of actions related to wireless network technologies being viewable by the administrator(s) associated with wireless network actions. The present example can send notifications for actions set by the administrator.

FIG. 1B is a flow diagram illustrating the user installing the invention on a device through the disconnection from wireless network technology. The present example illustrates the flow or process of a user connection through disconnection when the invention is presently synced with a device and wireless network technology(ies) access has been previously granted. The present example illustrates invention manually or automatically gathering user details and user’s device details to upload for wireless network technology access related to user and device stipulations that administrators have the option of setting and changing. The present example illustrates the user searching for visible wireless network technology(ies) and requesting access to visible wireless network technology(ies). The present example illustrates the user receiving a request from an administrator(s) to access wireless network technology(ies). The present example illustrates a user that meet administrator’s wireless network technology(ies) stipulation’s; can connect to wireless network technology(ies) when the user’s device is in the proximity of wireless network technology(ies). The present example illustrates the user’s connecting (automatically, manually, in some case using biometrics) to wireless network technology(ies) using a configured device stipulated by an administrator(s) related to a wireless network technology(ies). The present example illustrates the initiation of dialogue between the administrator(s) and the user(s) once the users’ device(s) is connected to a wireless network technology(ies). The present example illustrates modules activated or deactivated related to stipulations set by the administrator. The present example illustrates open dialogue and parameters. The present example illustrates the sending of notifications and the documentation for analytics; of actions related to wireless network technologies being viewable by the user(s) associated with wireless network actions.

FIG. 1B The present example illustrates B101 represents user install invention. B102 represents upload details that will be used for profile for wireless network technology(ies) SPECIFIC access and device configuration. B103 represents receive network invite and install invention if not already installed. B104 represents select from visible wireless networks to choose from. B105 represents request granted to network. B106 represents connect to network via security protocol (biometric (fingerprint, eye scanner, heart rate monitor, voice, pressure sensor, temperature etc.... depends on device options) or automatic connect when in proximity (administrator(s) determines requirements), device is configured and notifications are sent. B107 represents device is configured to receive and send data based on access point technology and administrator guidelines. B108 represents open dialogue to send and receive data. A109 represent parameter calendar protocol (based on administrator granted permissions). B109 represents social media feed for connection to network (optional) B110 represents social media feed for disconnection from network (optional) B111 represents disconnect (manually (can require biometrics to disconnect) or leave proximity) for network and notifications are sent. B112 represents documentation calendar

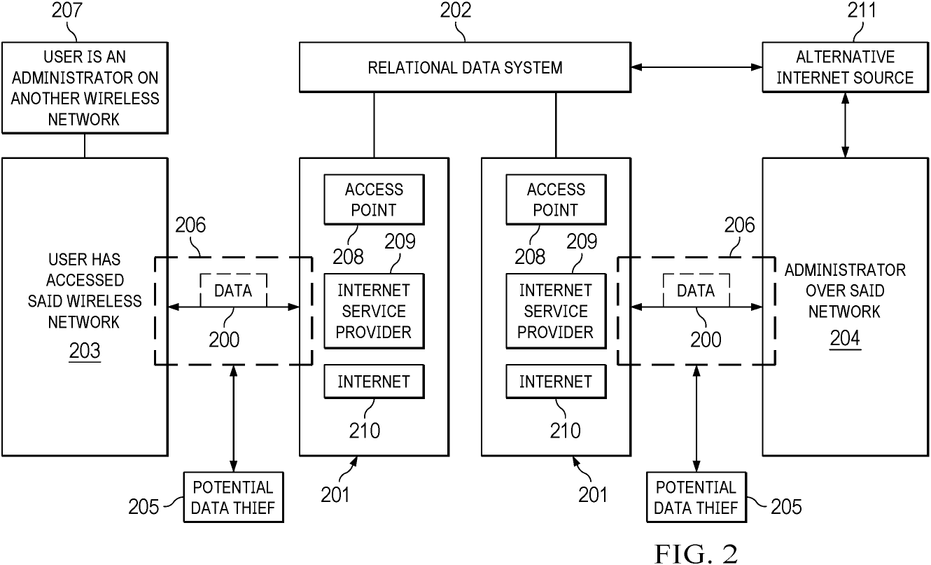

FIG. 2 The present example illustrates a threat of data being stolen at vulnerable increments by potential thief(s) that may use (packet sniffers are any other type of resource used to intercept information or data...etc.). The present example illustrates that data is safe for all intended for parties. The present example illustrates how the invention can detour unwanted viewers by presenting plain text that is encrypted or intertwined with malicious text. The present example illustrates how making the information being transferred safe while possibly causing damage to a device(s) of unwanted viewers. If the data is saved by unwanted viewers to a device and stored for later use; upon examination, the data will present itself as desirable text. Upon decryption, the device(s) that is used to handle stolen data will be compromised. The present example illustrates that data is filtered and quarantined by the invention on devices data is intended for to protect devices data is intended for. The present example illustrates a administrator can send or receive data remotely using an alternative internet source or while connected to the wireless network that is being administered. The present example illustrates the administrator can be a user on a network that the administer is not governing while simultaneously governing other wireless network(s). Undesignated users can have a device compromised.

FIG. 2. 203 represent a user being granted wireless network access while being an (207) administrator on other wireless network(s) using the same device. 200 represent data, malicious data blend that is in transit to the designated device. 201 represent combination of (208, 209, 210). 208 represent access point. 209 represent internet service provider. 210 represent internet. 202 represent relational data system. 204 represent administrator. 205 represent potential data thief. 206 represent vulnerable area for a thief to steal data as a user or administrator is either sending or receiving information. 211 represent alternative internet source that offer the administrator remote access. The administrator(s) can remotely access or connect a wireless network.

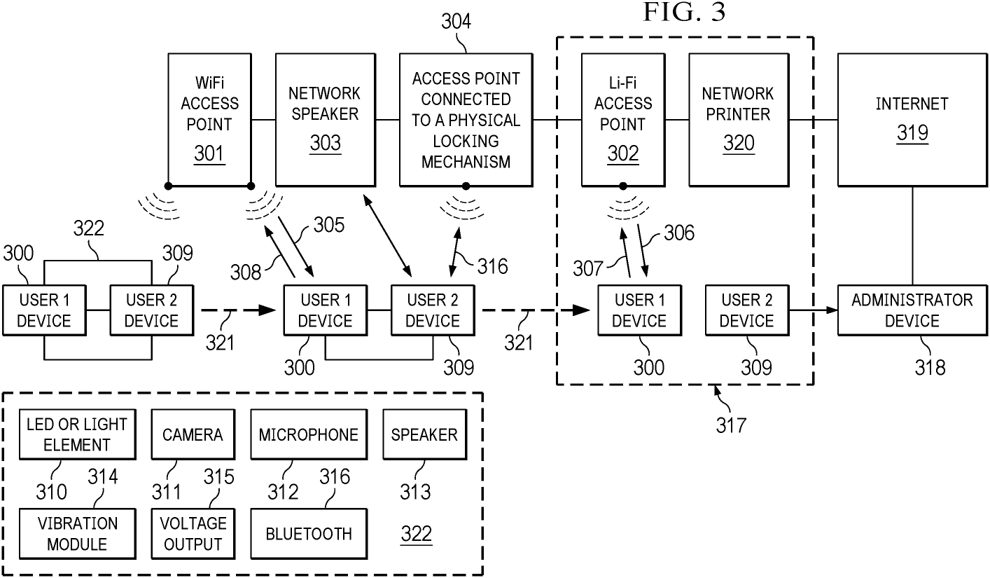

FIG. 3 The present example illustrates device(s) connection and initiation related to wireless network technology(ies) when in proximity. The present example illustrates multiple access point technology types. The present example illustrates the configuration of the device to receive and send data based on the devices’ available functionality, type of wireless network technology, and the location on the wireless network technology. The present example illustrates devices’ is configured to adapt to the wireless network based on wireless network technology(ies) details once devices connect signal being broadcasted by a wireless network technology(ies). The present example illustrates access point details are used to identify capabilities and functionality of the access points that relate to wireless network technology(ies). The present example illustrates wireless network technology(ies) detecting devices’, configuration of a device for switching to connect and disconnect to send and receive data as device(s) move through wireless network technology(ies). The present example illustrates the configuration of the device to receive and send data based on the devices’ available functionality, type of wireless network technology, and the location on the wireless network technology. The present example illustrates the users’ device being configured to receive and send data, gain access to entrances governed by wireless network technologies, and access transmittable resources connected to wireless network technologies. The present example illustrates that specific functionality on a device can be deactivated that can cause restrictions for the device to receive information or perform specific functions. The present example illustrates specific devices’ having its own unique connection configuration based on details related to wireless network technology(ies) details and administrator guidelines. The present example illustrates devices’ internal signal strength level is adjusted to negotiate range of wireless network technology(ies) for the purpose of being specific to specific access points.

FIG. 3. 322 represents possible functionality of a devices 300 and 309. 310 represents led or light element on a device. In Li-Fi technology, the element of light is used to send data. 311 represents camera on a device. In Li-Fi technology, camera is used to receive data. 312 represents microphone on a device. 313 represents speaker on a device. 314 represents vibration module on a device. 315 represent voltage output on a device. 316 represent Bluetooth functionality on device. The invention can use details to isolate function and configure a device to connect, receive, and send data via the wireless network. Based on wireless network guidelines set by an administrator, certain functionality of a device is initiated. (ex. Recording, sending voltage etc....) 300 represent user 1 device. 309 represent user 2 device. 301 represents Wi-Fi access point. The present example illustrates that when 300 and 309 enters the proximity of a access granted wireless network preset data is automatically pushed to designated devices. The present example illustrates 300 is configured to connect to 301 and receive data using 301 expressed with 305. 305 represents data going to a device via Wi-Fi technology. 308 represents data being sent from 300 to 301 via Wi-Fi technology. The present example illustrates as 300 progress through a location, 300 can connect to 302. 302 represents Li-Fi access point. 303 represents network speaker. 300 or 309 can access the wireless network and based on granted permissions, 300 or 309 can access the audio or video system. The present example illustrates 309 accessing the wireless network, the microphone function associated with 309 allows the user to speak through the device which is heard on 303. Furthermore, the present illustration shows that 309 is next to 300 but 309 is restricted to connect to 301 for the purpose of receiving data. 304 represents wireless access point (various technology) connected to a lock to an entrance. 306 represents data going to a device via Li-Fi technology. Assume that 300 and 309 have the same functionality. The present example illustrates that 300′s camera and lighting feature are activated to receive and send data related to Li-Fi technology. 309 features are deactivated to restrict reception of communication. 307 represents data being sent from a device via Li-Fi technology. The present example illustrates 300 moving from access point to access point. The present example illustrates as 300 or 309 progress, 300 or 309 is configured to connect and adapt to multiple access point technologies set by an administrator. Only a few are in the present diagram for the purpose of explanation. 321 represents devices moving from access point to access point. The present example illustrates data transferred to 300 or 309 may require the user of 300 or 309 to return the data signed to an administrator. The present example illustrates that data sent to a wireless network upon being sent from 300 or 309 will automatically or manually be sent to 320. 320 represents network printer. The present example illustrates access point are connected to locks 304 (magnetic or otherwise). The present example illustrates 300 and 309 access the wireless network close to the same moment in time. The present example illustrates 300 and 309 are a part of the same party and maybe required to stay together. The present example illustrates that presence of users are visible and open dialogue between users is available. The present example illustrates 300 and 309 progress through the wireless network environment together. The present example illustrates 309 separates from 300 in 317. The present example illustrates 309 separating from 300 requires 300 to verify that 300 is in proximity of 300′s device. (Biometrics, access pin etc.). The present example illustrates 300 or 309 is in proximity of 304, connection (316 represent connection to 304) to 304 is made in which access to locked area is granted biometric access pin etc. confirmation may be needed related to access secured area. 318 represents an administrator device. 319 represent the internet. The present example illustrates 318 can manage the wireless network remotely via internet or connected to said network. The present example illustrates a simplified scenario. The present example does not illustrate a limit of users or administrators, wireless technologies, devices or functionality.

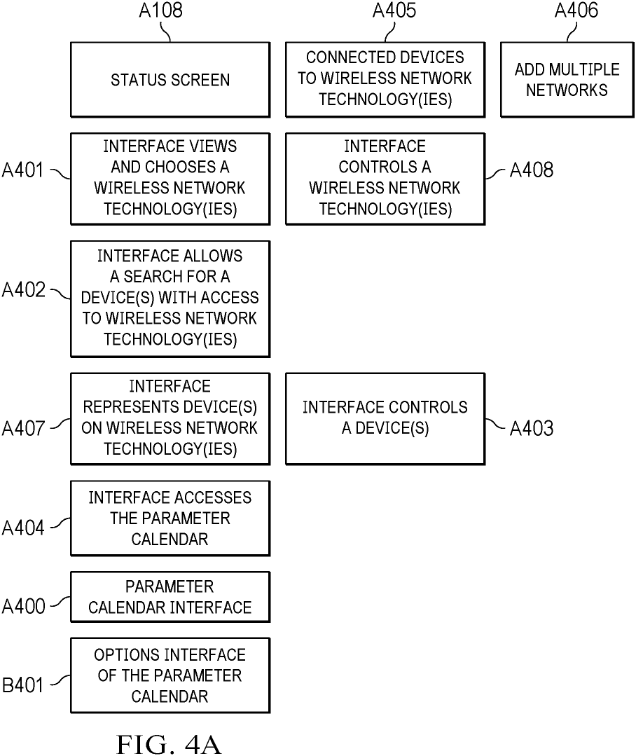

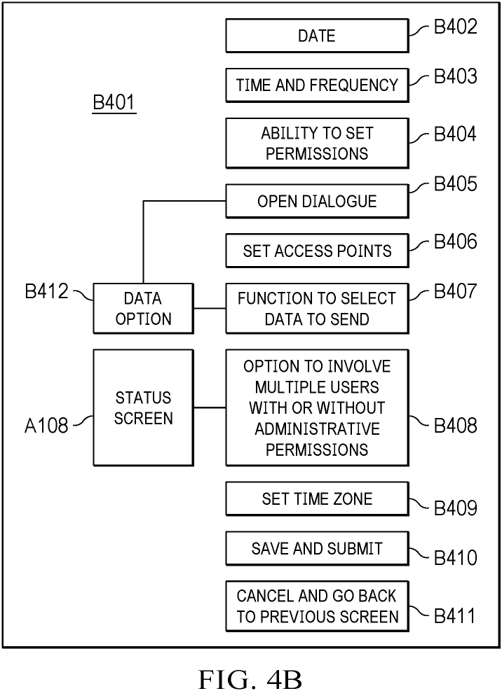

FIG. 4A. The present example illustrates a flow related to accessing the parameter calendar interface process on a device(s) that is used to determine parameters for sending data/media to users and opening dialogue functionality available for administrator(s) and user(s). The present example illustrates a wireless network and a device count of connected and disconnected devices. The present example illustrates the ability to add a wireless network. The present example illustrates viewing of wireless network technology(ies) status, protocol to select what wireless network technology(ies), select what device(s), add a wireless network technology(ies), set permissions of a wireless network technology(ies), search for device(s), govern device permissions, access parameter calendar, and select main menu. The present example illustrates data/media protocol choose what network and choose what user.

In the present example FIG. 4A represents the flow of how an administrator(s) may go through the process of viewing connected devices on multiple wireless network technology(ies) on the status screen. In the present example FIG. 4A represents how an administrator(s) may select users form wireless network technology(ies) to use the parameter calendar. A108 is from FIG. 1A and represent the status screen. (The status screen has the ability but not limited to viewing connected and connected devices to wireless network technology(ies) (A405). A406 provides the option to add multiple networks. A401 is the interface that view and choose a wireless network technology(ies). A408 is the interface that control a wireless network technology(ies) and govern permissions of a wireless network technology(ies). A402 is the interface that allow a search for a device(s) with access to wireless network technology(ies). A407 is the interface that represent device(s) on wireless network technology(ies). A403 is the interface that control a device(s) and govern permissions of a device(s). A404 is the interface that access the parameter calendar. A400 is the parameter calendar interface. B401 is the options interface of the parameter calendar. 0 is the interface is a representation of a main menu.

FIG. 4B. The present example illustrates a parameter calendar interface process on a device(s) that is used to determine parameters for sending data/media to users and opening dialogue functionality available for administrator(s) and user(s). The present example illustrates data/media protocol choose what choosing what access point(s) must be connected too for the user to establish a documented connection, what access point the user must be connected to send and receive data, what data to send is to be sent to the user, when and frequency data is being sent to the user giving the option of send via network calendar preset parameters. choosing what access point(s) must be connected too for the user to establish a documented connection, what access point the user must be connected to send and receive data, what data to send is to be sent to the user; when and frequency data is being sent to the user giving the option of send via network calendar preset parameters.

FIG. 4B. The present example illustrates associated process related to a parameter calendar method. The present example illustrates a parameter calendar interface functionality. The present example illustrates flow once one or more wireless networks are selected and one are more users with or without administrative permissions is selected. The present example illustrates how permitted users with or without administrative permissions can send data using the wireless network as a medium. The present example illustrates options for sending B402 date, B403 time and frequency (preset time, real time, or when users device connects to the wireless network technologies), B404 ability to set permissions, B405 open dialogue, B412 represents data option (text, audio, video, etc.). B406 set access points (one or more) that will receive data. B407 represent the function to select data to send. B412 represents data option (text, audio, video, etc.). B408 is the option to involve multiple users with or without administrative permissions. B409 set time zone. 410 save and submit. 411 represent cancel and go back to precious screen. B401 represent the embodiment.

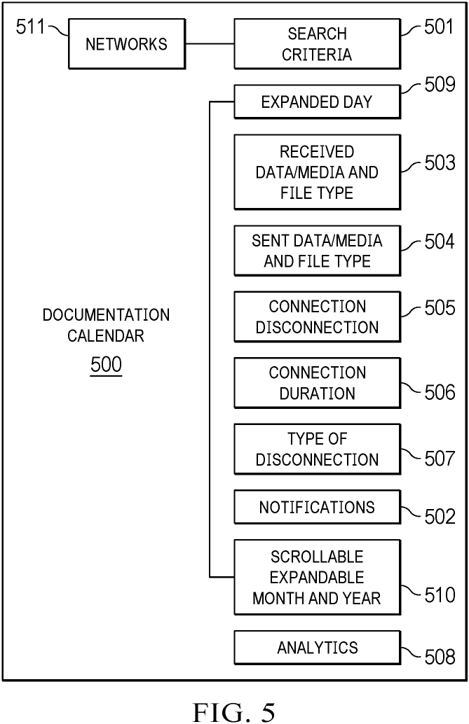

FIG. 5 The present example illustrates the viewable calendar interface for documentation on device(s) available for administrator(s) and user(s). The present example illustrates a calendar interface on a devices’ internal calendar or the invention offers a calendar to supplement the purpose in which the calendar is used. The present example illustrates calendar function can be used to document all aspects of correspondence with the invention. The present example illustrates feature and functions associated with the internal calendar. The present example illustrates but not limited to documented activities associated with a wireless network technology(ies), notifications that are received, files received, files sent, connection and disconnection time, connection duration time, how a device is disconnected from a wireless network technology(ies), and analytics of actions documented. The present example illustrates screens with the ability to expand to express functionality, features, or information. The present example illustrates the ability to have search criteria to isolate actions.

FIG. 5. 500 represent documentation calendar. 511 represent what networks. 501 represent search criteria (notifications, time, date, file type, connection, duration, disconnection, etc.). 502 represent notifications. 503 represent received data/media and file type. 504 represent sent data/media and file type. 505 represent connection disconnection. 506 represent connection duration. 507 represent type of disconnection. 508 represent analytics. 509 represent expanded day. 510 represent scrollable expandable month and year.

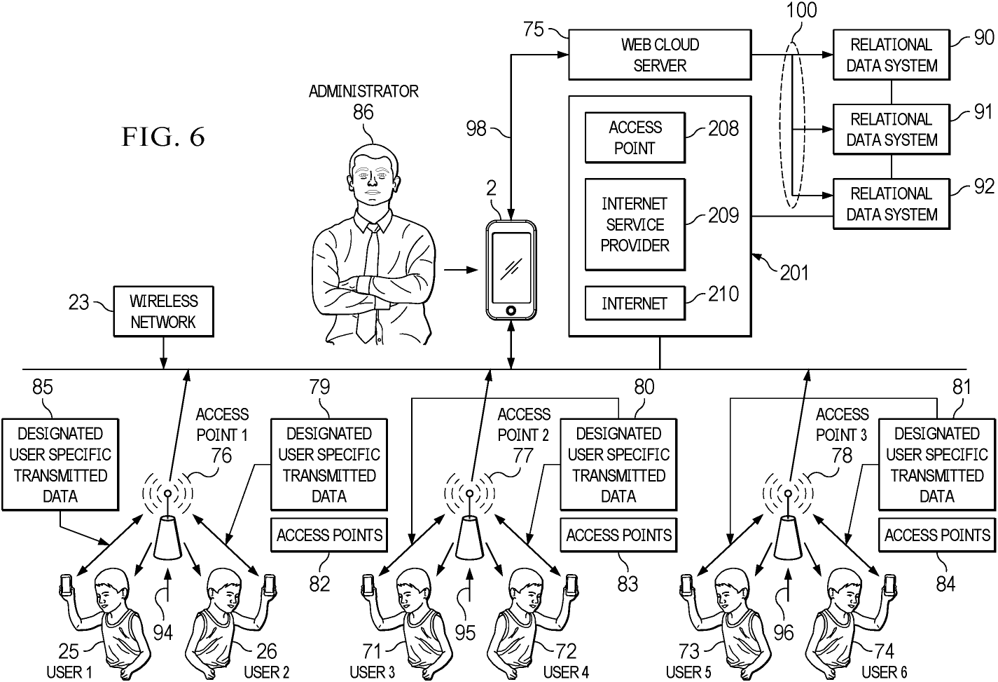

FIG. 6. To elaborate multiple functionalities, the present example illustrates a shopping environment. The present example illustrates a wireless network associated with a shopping environment. The present example illustrates multiple locations associated with a shopping environment. The present example illustrates multiple users associated with a shopping environment. The present example illustrates multiple access points and wireless network technologies associated with a shopping environment. The present example illustrates related data systems and api(s) that are used to gather, send, and receive associated with a shopping environment. The present example illustrates relational data systems and API(s) that are used to document, configure, and communicate actions to designated parties. The present example illustrates relational data systems and api(s) that are used to notify, and issue transaction details associated with actions while users are connected to a wireless network technology associated with a shopping environment. The present example illustrates relational data systems and API(s) that are used to isolate each user or multiple users while connected to wireless network technologies. The present example illustrates an administrator facilitating or initiating the manual are automatic transmission of data.

FIG. 6. 76 represent access point 1 associated with the (wireless network (23). 77 represent access point 2 associated with 23. 78 represent access point 3 associated with 23. 90, 91, 92 represent relational data systems. 25 represent user1 with device. 26 represent user2 with device. 71 represent user3 with device. 72 represent user4 with device. 73 represent user5 with device. 73 represent user6 with device. 75 represent a web cloud server. 86 represent an administrator. 2 represent the administrator’s device that is used to facilitate actions associated with wireless network technologies. 85, 79, 80, 81, represent designated user specific transmitted data in an open dialogue between users and administrators connected to a wireless network technology(ies). 86 can grant sender and recipient permissions. 94, 95, 96, represent initiated data being sent to users connected to specific access points based on (locations associated with access points 82,83,84). 201 represent combination of (208, 209, 210). 208 represent access point. 209 represent internet service provider. 210 represent internet. 90,91,92 represent a relational data system that holds details related to wireless network technologies, users, administrators, and devices. (Ex. a model number of a device will give knowledge of the functionality of the device. a model number of an access point will give knowledge of the functionality of the access points. Device details are used to verify the device, User and administrator details are used to verify the person(s) with the device. All needed details or considered to configure a device. Wireless network technologies activities are documented and stored using 90,91,92. Parameters are stored to 90,91,92. Information depending on guidelines are stored to either 90,91,92 or the invention on the device. The present example illustrates an administrator can access wireless network technologies via wireless network connection or external internet. The present example illustrates api pushing and pulling information associated with connection details, user details, administrator details, correspondence details. The present example illustrates a simplified scenario. 98 and 100 represent api(s). The present example does not illustrate a limit of users or administrators, wireless technologies, devices or functionality. The present illustration is an example and is not meant to determine limits of individuals or components.

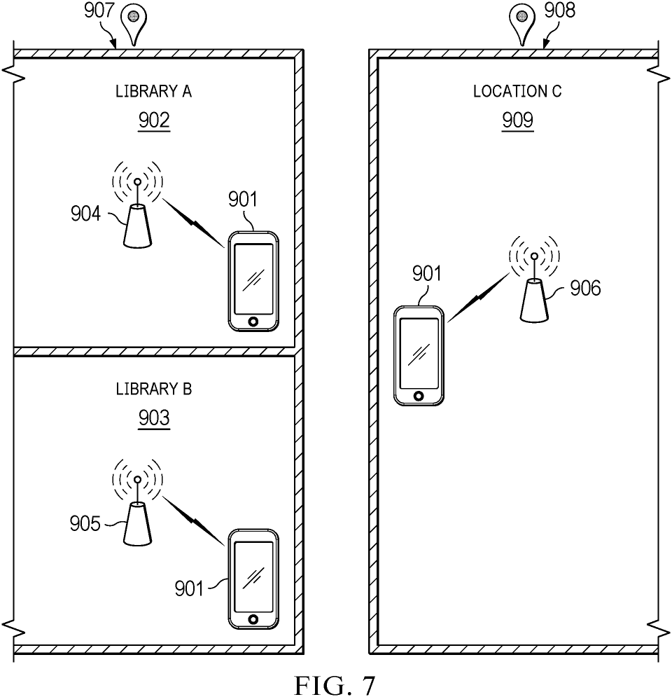

FIG. 7. The present example illustrates device(s) being configured to specifications of wireless network technology(ies). The present example illustrates two locations. The present example illustrates one location with one access point and another location with two access points. The present example illustrates the device coming into range and of a displayed access point. The present example illustrates a device connecting to a specific access point. The present example illustrates the device being configured to access point guidelines set by an administrator(s) related to said access point.

FIG. 7. The present example illustrates (907 as the structure) that is housing (access points 905 and 904). The present example illustrates 907 having a documentable physical location that may be used as a component of the protocol that regulates configuration of a device in the manner of connecting to a specific access point. The present example illustrates (901 -the user’s device(s)) accessing a wireless network of a (902 library) a silent section and (903 library food cafeteria), a section that does not encourage silence. The present example illustrates criteria that 901 is configured to adjust to the guidelines the administrator has set related to 902; as 901 connects to 904. The present example illustrates criteria that 901 is configured to adjust to the guidelines the administrator has set related to 903; as 901 connects to 905.The present example illustrates that 901 accessing 902 may include the silent mode to be enabled. The present example illustrates 901 being configured to meet guidelines set by the administrator(s) related to (908 structure). The present example illustrates 901 connecting to (access point 909). The present example illustrates (908 as a structure) that is housing (access point 906). The present example illustrates 908 having a documentable physical location that may be used as a component of the protocol that regulates configuration of a device in the manner of connecting to a specific access point. The present example illustrates two locations that may have separate parameters that are set to determine how a device will function while connected to the wireless network. The present example illustrates when a device connects to wireless network technology, camera(s), microphone(s), speaker(s), lighting components ...etc can be manipulated related to specific wireless network interactions.

Components describe above or meant only to exemplify various possibilities in no way should the Afro mentioned exemplary computer system limit the scope of the present disclosure. While environments of the invention have been illustrated and describe it will be clear that the invention is not limited to these environments only numerous modifications changes variations substitutions an equivalence will be apparent to those skilled in the art without departing from the spirit in scope of the invention as described in the claims.

What is claimed:

1. A system, method and apparatus associated with Wireless technology called Parameter to initiate dialogue technology (PIDT); implement an encrypted security protocol wherein users’ devices and administrator pre-determined destination area will connect and determine efficient way to connect and support communication.

2. A system, method, and apparatus according to claim 1, wherein the software application determines what the technological makeup of device is being used and configures wireless network to communicate with said device.

3. A system, method, and apparatus according to claim 1, wherein the software application determines what the technological makeup of network components are being used and configures the user’s device to communicate with said wireless network.

4. A system, method, and apparatus according to claim 1, wherein the software application allows network administrators to set protocols that will control device functionality when device is connected to a wireless network and a GPS location.
